(19) United States
(12) Patent Application Publication
(10) Pub. No.: US 2017/0024429 A1
(43) Pub. Date: Jan. 26, 2017

(54) REAL-TIME METRIC AGGREGATION FOR TRANSACTIONAL SYSTEMS

(71) Applicant: Oracle International Corporation, Redwood Shores, CA (US)

(72) Inventor: Vardhamanithi Narayanan Sivasailam, Karnataka (IN)

(73) Assignee: Oracle International Corporation, Redwood Shores, CA (US)

(21) Appl. No.: 15/158,169

(22) Filed: May 18, 2016

Related U.S. Application Data
(60) Provisional application No. 62/195,519, filed on Jul. 22, 2015.

(51) Int. Cl. G06F 17/30; G06Q 30/02

(52) U.S. Cl. CPC G06F 17/30377; G06Q 30/0202

(57) ABSTRACT

A method for displaying current values of data items associated with different hierarchical levels in a hierarchy is disclosed. A differential value to be added to a stored value of each of a set of data items is stored. A request for current values of the set of data items is received. The differential value is added to the stored value of each data item to determine a current value of each data item. The differential value is added to the stored values of data items associated different hierarchical levels in a hierarchy. The current values of the data items are displayed.

### BENEFIT CLAIM

### Incorporation by Reference

This application claims the benefit of U.S. Provisional Patent Application No. 62/195,519, filed Jul. 22, 2015, which is hereby incorporated by reference in its entirety.

### TECHNICAL FIELD

The present disclosure relates to management of data. In particular, the present disclosure relates to real-time aggregation of metrics in transactional systems.

### BACKGROUND

Transactional systems are designed to facilitate and manage data in real-time. Many transactional systems experience high throughput of compute-intensive data. A goal of transactional systems is to present information accurately reflecting real-time data while optimizing speed and performance.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### GENERAL OVERVIEW

In one or more embodiments, current values of data items associated with different hierarchical levels in a hierarchy are requested by a user. The current values of the data items are determined by adding a differential value to the stored values of the data items. The current values of the data items are displayed at a user interface.

In one or more embodiments, a set of differential values are stored in a log. A subset of the differential values are associated with a particular data item. An association between a particular differential value and a particular data item exists if the particular differential value is associated with an attribute in a hierarchy that is (1) the same as the attribute of the particular data item, or (2) a child or descendant of the attribute of the particular data item in the hierarchy.

In one or more embodiments, each differential value that is associated with a particular data item is added to the stored value of the particular data item to determine a current value of the particular data item.

### Example Embodiments

In one or more embodiments, stored values of a set of data items are identified. The set of data items are associated with one or more attributes in different hierarchical levels of one or more hierarchies.

In an example, a set of data items may represent forecasted revenues. A subset of data items may correspond to different hierarchical levels in a territory hierarchy. Another subset of data items may correspond to different hierarchical levels in a product hierarchy.

In the territory hierarchy, each hierarchical level may represent a different geographical scope. A first hierarchical level may represent a continent. Attributes of the first hierarchical level may include “North America,” “Europe,” and “Asia.” A second hierarchical level, below the first hierarchical level, may represent a country. Attributes of the second hierarchical level may include “United States,” “France,” and “Spain.” A third hierarchical level, below the second hierarchical level, may represent a state or province. Attributes of the third hierarchical level may include “California,” and “New York.” In this example, the attribute “North America” is a parent of the attribute “United States,” which is a parent of both “California” and “New York.” A data item associated with “North America,” in the first hierarchical level, would represent the forecasted revenue for North America. Another data item associated with “United States,” in the second hierarchical level, would represent the forecasted revenue for the United States.

In the product hierarchy, each hierarchical level may represent a product category of a different scope. A first hierarchical level may represent a broad product category. Attributes of the first hierarchical level may include “Electronic Devices,” and “Home Appliances.” A second hierarchical level, below the first hierarchical level, may represent a narrower product category. Attributes of the second hierarchical level may include “Computers,” “Smartphones,” and “Refrigerators.” A third hierarchical level, below the second hierarchical level, may represent a specific product line. Attributes of the third hierarchical level may include “Dell Inspiron Computers” and “Samsung Galaxy Smartphones.” In this example, the attribute “Electronic Devices” is a parent of the attributes “Computers” and “Smartphones.” The attribute “Computer” is a parent of the attribute “Dell Inspiron Computers.” A data item associated with “Electronic Devices,” in the first hierarchical level, would represent the forecasted revenue for electronic devices. Another data item associated with “Computers,” in the second hierarchical level, would represent the forecasted revenue for computers.

In an example, a product hierarchy may exist within a territory hierarchy. Under each attribute of each hierarchical level of the territory hierarchy, a product hierarchy may exist. Under “Europe” of the territory hierarchy, all hierarchical levels of the product hierarchy may exist. A data item associated with a hierarchical level of the product hierarchy under “Europe” may represent the forecasted revenue for that product category within Europe. Under “United States” of the territory hierarchy, all hierarchical levels of the product hierarchy may also exist. A data item associated with a hierarchical level of the product hierarchy under “United States” may represent the forecasted revenue for that product category within the United States.

In an embodiment, the stored values of the data items are computed periodically, based on values of a set of base data items at the time of computation. The values of the set of base data items are received from a user or an external system. The set of base data items are also associated with one or more attributes in one or more hierarchies. The value of a data item that is associated with a particular attribute in a hierarchy is computed based on values of a particular subset of base data items. Each of the particular subset of base data items are associated with an attribute that is (1) the same as the particular attribute, or (2) a child or descendant of the particular attribute in the hierarchy.

In an example, a set of data items may represent forecasted revenue corresponding to a territory hierarchy. Each of the set of data items may represent the forecasted revenue for a particular geographical region, such as “North America,” “United States,” “Canada,” and “California.”

A set of base data items may represent individual forecasted deals. Each individual forecasted deal may include the products being sold, and the location of the prospective customer. The individual forecasted deals may be entered by a sales representative. A first forecasted deal may be to sell Dell Inspiron Computers to a customer located in California, United States, for $10,000. A second forecasted deal may be to sell Samsung Galaxy Smartphones to a customer located in New York, United States, for $15,000. A third forecasted deal may be to sell Dell Inspiron Computers to a customer located in Ontario, Canada, for $18,000.

One of the data items may represent forecasted revenue for the geographical region, “California.” A value of the data item would be computed based on the value of the first forecasted deal because the first forecasted deal is associated with an attribute (“California”) that is the same as the attribute of the data item (“California”). The forecasted revenue for “California” would be $10,000. Another of the data items may represent forecasted revenue for the geographical region, “United States.” A value of the data item would be computed based on the value of the first forecasted deal and the second forecasted deal. The first forecasted deal is associated with an attribute (“California”) that is a child of the attribute of the data item (“United States”). The second forecasted deal is also associated with an attribute (“New York”) that is a child of the attribute of the data item (“United States”). The forecasted revenue for “United States” would be $25,000 ($10,000+$15,000). In this example, the values of multiple data items would be computed based on the value of the first forecasted deal.

In one or more embodiments, one or more differential values are received and stored in a log. A differential value represents a difference between a current value of a base data item and the value of the base data item that was last specified. The value of the base data item that was last specified may be the value of the base data item at the time the stored values for the set of data items was last computed. Alternatively, the value of the base data item that was last specified may be the value of the base data item at the time the last differential value, for the data item, was received. The differential value may be received from a user or an external system.

In an example, a base data item may represent a particular forecasted deal to sell Dell Inspiron Computers to a customer located in California, United States. A sales representative handling the particular forecasted deal may specify the value of the particular forecasted deal to be $10,000. Data items representing the forecasted revenue for particular geographical regions may be computed based on the particular forecasted deal, using the value $10,000. The results of the computations are stored as stored values of the data items. Subsequently, the sales representative may determine that the value of the particular forecasted deal should be $15,000, rather than $10,000. A differential value for the particular forecasted deal would be a difference between the current value ($15,000) and the value at the time the stored values of the data items were computed ($10,000), which is $5,000.

In one or more embodiments, a request for current values of one or more data items is received. The current values of the data items are to be displayed at a user interface. The request may be received from any user with authorized access, such as a sales representative, a sales manager, or a chief executive officer.

In an example, a user may request the current value of a single data item, such as the forecasted revenue for Computers sold in California. In another example, a user may request the current values of multiple data items in a territory hierarchy. The data items in a territory hierarchy include a data item representing forecasted revenue for California, and another data item representing forecasted revenue for the United States.

In one or more embodiments, associations between the data items requested by the user and a subset of differential values, previously stored in a log, are determined. An association between a particular differential value and a particular data item exists if the particular differential value corresponds to a base data item that is associated with an attribute in a hierarchy that is (1) the same as the attribute of the particular data item, or (2) a child or descendant of the attribute of the particular data item in the hierarchy.

In an example, a first differential value of $5,000 may correspond to a base data item representing a forecasted deal to sell Dell Inspiron Computers to a customer located in California, United States. An attribute associated with the first differential value would be “California.” A second differential value of $6,000 may correspond to a base data item representing forecasted deal to sell Dell Inspiron Computers to a customer located in New York, United States. An attribute associated with the second differential value would be “New York.” The first differential value and the second differential value may be stored in a log, as summarized in Table 1 below.

TABLE 1

| Geographical | | Differential Value for |
|---|---|---|
| Region of the | Specific Product Line of the | Forecasted Revenue for the |
| Deal | Deal | Deal |
| California | Dell Inspiron Computers | $5,000 |
| New York | Dell Inspiron Computers | $6,000 |

Data items requested by a user may include (a) the forecasted revenue for California, (b) the forecasted revenue for New York, and (c) the forecasted revenue for the United States. An attribute associated with the forecasted revenue for California would be “California.” An attribute associated with the forecasted revenue for New York would be “New York.” An attribute associated with the forecasted revenue for the United States would be “United States.” Stored values for the data items requested by the user may be identified, as summarized in Table 2 below.

TABLE 2

| | Stored Value for Forecasted |
|---|---|
| | Revenue for the |
| Geographical Region | Geographical Region |
| United States | $800,000 |
| California | $300,000 |
| New York | $500,000 |

The attribute of the forecasted revenue for California (“California”) is the same as the attribute associated with the first differential value (“California”). Therefore, the forecasted revenue for California would be associated with the first differential value. The attribute of the forecasted revenue for the United States (“United States”) is a parent of the attribute associated with the first differential value (“California”). Therefore, the forecasted revenue for the United States would be associated with the first differential value. The attribute of the forecasted revenue for New York (“New York”) is neither a parent of nor the same as the attribute associated with the first differential value (“California”). Therefore, the forecasted revenue for New York would not be associated with the first differential value. Similarly, the forecasted revenue for New York and the forecasted revenue for the United States would be associated with the second differential value, but not the first differential value.

In one or more embodiments, for each data item that is requested by a user, one or more differential values associated with a particular data item is added to the stored value of the particular data item to determine a current value of the particular data item.

Continuing the example above, since the forecasted revenue for California is associated with the first differential value, the first differential value ($5,000) is added to the stored value of the forecasted revenue for California ($300,000). The sum ($305,000) is determined to be the current value of the forecasted revenue for California. Since the forecasted revenue for New York is associated with the second differential value, the second differential value ($6,000) is added to the stored value of the forecasted revenue for New York ($500,000). The sum ($506,000) is determined to be the current value of the forecasted revenue for New York. Since the forecasted revenue for the United States is associated with both the first differential value and the second differential value, both the first differential value ($5,000) and the second differential value ($6,000) are added to the stored value of the forecasted revenue for the United States ($800,000). The sum ($811,000) is determined to be the current value of the forecasted revenue for the United States. The current values of the data items requested by the user are summarized in Table 3 below.

TABLE 3

| | Current Value for Forecasted |
|---|---|
| | Revenue for the |
| Geographical Region | Geographical Region |
| United States | $811,000 |
| California | $305,000 |
| New York | $506,000 |

In one or more embodiments, the current values of the data items requested by the user are displayed at a user interface. Even though the stored values of the data items may not have been updated, the current values of the data items are displayed. Thus, the values of the data items that are presented to a user reflect real-time data.

In one or more embodiments, the stored values of the data items are periodically updated. A stored value of a particular data item is updated by adding one or more differential values associated with the particular data item to the stored value of the particular data item. The differential values are then removed from the log.

6. Miscellaneous: Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

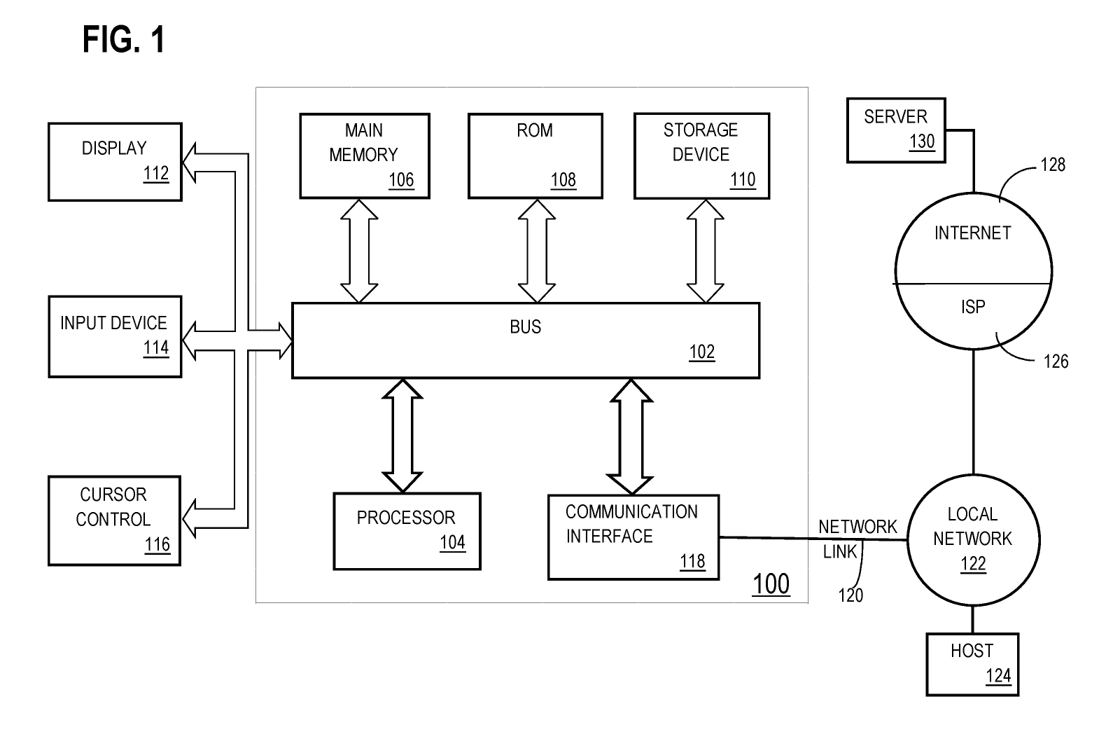

For example, FIG. 1 is a block diagram that illustrates a computer system 100 upon which an embodiment of the invention may be implemented. Computer system 100 includes a bus 102 or other communication mechanism for communicating information, and a hardware processor 104 coupled with bus 102 for processing information. Hardware processor 104 may be, for example, a general purpose microprocessor.

Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Such instructions, when stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 may implement the techniques described herein using customized hard-wired logic, one or more ASICs or FPGAs, firmware and/or program logic which in combination with the computer system causes or programs computer system 100 to be a special-purpose machine. According to one embodiment, the techniques herein are performed by computer system 100 in response to processor 104 executing one or more sequences of one or more instructions contained in main memory 106. Such instructions may be read into main memory 106 from another storage medium, such as storage device 110. Execution of the sequences of instructions contained in main memory 106 causes processor 104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 110. Volatile media includes dynamic memory, such as main memory 106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 102. Transmission media can also take the form of acoustic or light waves, such as those generated during radio-wave and infra-red data communications.

Various forms of media may be involved in carrying one or more sequences of one or more instructions to processor 104 for execution. For example, the instructions may initially be carried on a magnetic disk or solid state drive of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card, cable modem, satellite modem, or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are example forms of transmission media.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118.

The received code may be executed by processor 104 as it is received, and/or stored in storage device 110, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
storing a differential value to be added to each stored value in a set of stored values corresponding to a set of data items, each of the set of data items corresponding to a different hierarchical level in a hierarchy;
prior to adding the differential value to each stored value in the set of stored values: receiving a first request for a current value of a first data item in the set of data items;
adding the differential value to the stored value of the first data item to determine the current value of the first data item; and
displaying the current value of the first data item.

2. The medium of claim 1, wherein the operations further comprise:
prior to adding the differential value to each stored value in the set of stored values: receiving a second request for a current value of a second data item in the set of data items;
adding the differential value to the stored value of the second data item to determine the current value of the second data item; and
displaying the current value of the second data item concurrently with the current value of the first data item.

3. The medium of claim 1, wherein the first request is further for a current value of a second data item in the set of data items, and wherein the operations further comprise:
adding the differential value to the stored value of the second data item to determine the current value of the second data item; and
displaying the current value of the second data item concurrently with the current value of the first data item.

4. The medium of claim 1, wherein the operations further comprise:
determining that the differential value is to be used for updating a second data item based on the second data item being a parent to the first data item in the hierarchy;
adding the differential value to a stored value of the second data item to determine a current value of the second data item; and
displaying the current value of the second data item concurrently with the current value of the first data item.

5. The medium of claim 1, wherein the operations further comprise:
selecting the set of data items, from a plurality of data items, for modification by the differential value based on the differential value being associated with the set of data items.
